(19) United States
(12) Patent Application Publication
(10) Pub. No.: US 2024/0067189 A1
(43) Pub. Date: Feb. 29, 2024

(54) CONTROL DEVICE AND CONTROL METHOD

(71) Applicant: Mitsubishi Electric Corporation, Tokyo (JP)

(72) Inventors: Takumi SATO, Tokyo (JP); Takuji MORIMOTO, Tokyo (JP); Genki TANAKA, Tokyo (JP)

(73) Assignee: Mitsubishi Electric Corporation, Tokyo (JP)

(21) Appl. No.: 18/270,549

(22) PCT Filed: Mar. 22, 2021
(86) PCT No.: PCT/JP2021/011618

§ 371 Date: Jun. 30, 2023

(51) Int. Cl. B60W 50/00

(52) U.S. Cl. CPC B60W 50/00; B60W 60/00

(57) ABSTRACT

Included are: a surrounding situation acquiring unit that acquires surrounding situation information regarding a situation around a control target apparatus; a control amount inferring unit that infers a control amount of the control target apparatus on the basis of the surrounding situation information and acquires attention-paid region information regarding an attention-paid region in the surrounding situation information used when the control amount is inferred; a target detecting unit that detects a position of a target present around the control target apparatus on the basis of the surrounding situation information acquired by the surrounding situation acquiring unit; and a reliability determining unit that determines reliability of the control amount inferred by the control amount inferring unit on the basis of the attention-paid region information acquired by the control amount inferring unit and target position information regarding the position of the target detected by the target detecting unit.

### TECHNICAL FIELD

The present disclosure relates to a control device and a control method that infer a control amount for controlling various apparatuses.

### BACKGROUND ART

A technique of inferring a control amount for performing control on an apparatus to be controlled (hereinafter, referred to as “control target apparatus”) on the basis of a model (hereinafter, referred to as “machine learning model”) that has been trained and is constituted by a neural network in machine learning is known.

In machine learning, since accuracy of the machine learning significantly depends on the amount or quality of training data in addition to its algorithm, various ideas have been applied to training data conventionally. For example, Patent Literature 1 discloses a technique of calculating a contribution degree given to an output result by an input item used to create a model created by a multilayer neural network, and generating a high contribution degree item data set on the basis of the input item having a high contribution degree.

### CITATION LIST

### Patent Literature

Patent Literature 1: JP 2018-169959 A

### SUMMARY OF INVENTION

### Technical Problem

A machine learning model constituted by a neural network in machine learning does not necessarily output a reliable control amount in every situation. This is because the machine learning model cannot guarantee an output for an unknown state that is not a training target when machine learning is performed.

Therefore, even when training data and the like are improved by the conventional technique represented by the technique disclosed in Patent Literature 1, there is a problem that there is no guarantee that an inference result at the time of inferring an actual control amount based on a machine learning model created using the training data and the like is appropriate, in other words, there is no guarantee that the inference result is reliable.

The present disclosure has been made in order to solve the above problems, and an object of the present disclosure is to provide a control device capable of determining whether or not a control amount inferred as a control amount for controlling a control target apparatus is reliable.

### Solution to Problem

A control device according to the present disclosure includes: a surrounding situation acquiring unit to acquire surrounding situation information regarding a situation around a control target apparatus; a control amount inferring unit to infer a control amount of the control target apparatus on a basis of the surrounding situation information acquired by the surrounding situation acquiring unit and to acquire attention-paid region information regarding an attention-paid region in the surrounding situation information used when the control amount is inferred; a target detecting unit to detect a position of a target present around the control target apparatus on a basis of the surrounding situation information acquired by the surrounding situation acquiring unit; and a reliability determining unit to determine reliability of the control amount inferred by the control amount inferring unit on a basis of the attention-paid region information acquired by the control amount inferring unit and target position information regarding the position of the target detected by the target detecting unit.

### Advantageous Effects of Invention

According to the present disclosure, it is possible to determine whether or not a control amount inferred as a control amount for controlling a control target apparatus is reliable.

### BRIEF DESCRIPTION OF DRAWINGS

FIG. 1 is a diagram illustrating a configuration example of a control device according to a first embodiment.

FIG. 2 is a diagram for describing a configuration of a control amount inferring unit in the control device according to the first embodiment in detail.

FIG. 3 is a flowchart for describing an operation of the control device according to the first embodiment.

FIGS. 4A and 4B are each a diagram illustrating an example of a hardware configuration of the control device according to the first embodiment.

FIG. 5 is a diagram illustrating a configuration example of a control device according to a second embodiment.

FIG. 6 is a diagram for describing a configuration of a control amount inferring unit in the control device according to the second embodiment in detail.

FIG. 7 is a diagram illustrating a concept of an example of content of each scenario target information held in an attention-paid target database in the second embodiment.

FIG. 8 is a flowchart for describing an operation of the control device according to the second embodiment.

### DESCRIPTION OF EMBODIMENTS

Hereinafter, embodiments of the present disclosure will be described in detail with reference to the drawings.

### First Embodiment

A control device according to a first embodiment infers a control amount for controlling a control target apparatus.

In the first embodiment, it is assumed that the control target apparatus is a vehicle capable of automatic driving. The control device performs automatic driving control in a vehicle capable of automatic driving. Specifically, it is assumed that the control device performs automatic driving control in a vehicle by performing steering wheel control, throttle control, and brake control of the vehicle. Therefore, in the first embodiment, as the control amount for the control device to perform automatic driving control of the vehicle to be inferred by the control device, a steering wheel angle, a throttle opening, and a brake amount are assumed.

In the first embodiment described below, the steering wheel angle, the throttle opening, and the brake amount which are inferred by the control device are also collectively referred to as “control amount of vehicle”.

The control device adjusts acceleration/deceleration and steering of the vehicle by performing steering wheel control, throttle control, and brake control of the vehicle on the basis of the inferred control amount of the vehicle,

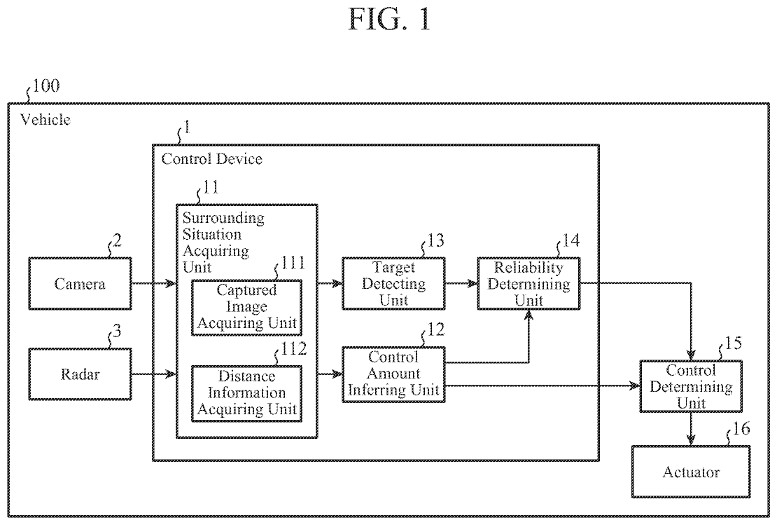

FIG. 1 is a diagram illustrating a configuration example of a control device 1 according to the first embodiment.

The control device 1 is mounted on a vehicle 100.

The control device 1 is connected to a camera 2, a radar 3, and a control determining unit 15. The control determining unit 15 is connected to an actuator 16.

The camera 2, the radar 3, the control determining unit 1:5, and the actuator 16 are mounted on the vehicle 100.

In FIG. 1, the control determining unit 15 is disposed outside the control device 1, but the control determining unit 15 may be disposed in the control device 1. As illustrated in FIG. 1, when the control determining unit 15 is disposed outside the control device 1, for example, the control determining unit 15 is disposed in an automatic, driving control device (not illustrated) that is mounted on the vehicle 100 and performs driving control of the vehicle 100.

The camera 2 captures surroundings of the vehicle 100. The camera 2 outputs an image obtained by capturing the surroundings of the vehicle 100 (hereinafter, referred to as “captured image”) to the control device 1.

The radar 3 detects a target such as another vehicle present around the vehicle 100.

Note that it is based on the premise that a capturing range of the camera 2 and a target detection range of the radar 3 overlap with each other.

The radar 3 outputs information indicating a distance to the detected target (hereinafter, referred to as “distance information”) to the control device 1. The distance information includes information regarding a distance between the vehicle 100 and the target and a position and an angle of the target as viewed from the vehicle 100.

In the first embodiment, the target means an object that can affect control of the vehicle 100. Specifically, in the first embodiment, the target means another traffic participant such as a pedestrian, a bicycle, or another vehicle, a road, a road mark, a road sign, a signal, a signboard, or the like. The target is set in advance depending on control content of the vehicle 100.

The control device 1 acquires the captured image output from the camera 2 and the distance information output from the radar 3 as information regarding a situation around the vehicle 100 (hereinafter, referred to as “surrounding situation information”). The control device 1 infers a control amount of the vehicle 100 on the basis of the acquired surrounding situation information. Specifically, the control device 1 infers the control amount of the vehicle 100 on the basis of the captured image included in the acquired surrounding situation information. In addition, the control device 1 determines a degree (hereinafter, referred to as “reliability”) indicating how reliable the inferred control amount of the vehicle 100 is for controlling the control target apparatus, which is in other words the vehicle 100, on the basis of the surrounding situation information.

The control device 1 outputs information regarding the inferred control amount of the vehicle 100 and the reliability of the control amount to the control determining unit 15. Details of the control determining unit 15 and the actuator 16 will be described later.

The control device 1 includes a surrounding situation acquiring unit 11, a control amount inferring unit 12, a target detecting unit 13, and a reliability determining unit 11. The surrounding situation acquiring unit 11 includes a captured image acquiring unit 111 and a distance information acquiring unit 112.

The surrounding situation acquiring unit 11 acquires surrounding situation information from the camera 2 and the radar 3.

Specifically, the captured image acquiring unit 111 of the surrounding situation acquiring unit 11 acquires, from the camera 2, a captured image obtained by capturing surroundings of the vehicle 100. The distance information acquiring unit 112 of the surrounding situation acquiring unit 11 acquires, from the radar 3, information indicating the distance to a target present around the vehicle 100.

The surrounding situation acquiring unit 11 outputs the acquired surrounding situation information to the control amount inferring unit 12 and the target detecting unit 13. Note that, here, the surrounding situation acquiring unit 11 outputs the surrounding situation information to the control amount inferring unit 12, but it is not limited thereto, and the surrounding situation acquiring unit 11 only needs to output at least the captured image acquired by the captured image acquiring unit 111 to the control amount inferring unit 12.

The control amount inferring unit 12 infers the control amount of the vehicle 100 on the basis of the surrounding situation information acquired by the surrounding situation acquiring unit 11, and acquires information (hereinafter, referred to as “attention-paid region information”) regarding a region to which attention should be paid (hereinafter, referred to as “attention-paid region”) in the surrounding situation information used when the control amount is inferred.

More specifically, the control amount inferring unit 12 infers the control amount of the vehicle 100 on the basis of the captured image included in the surrounding situation information acquired by the surrounding situation acquiring unit 11, and acquires attention-paid region information regarding an attention-paid region in the captured image when the control amount is inferred.

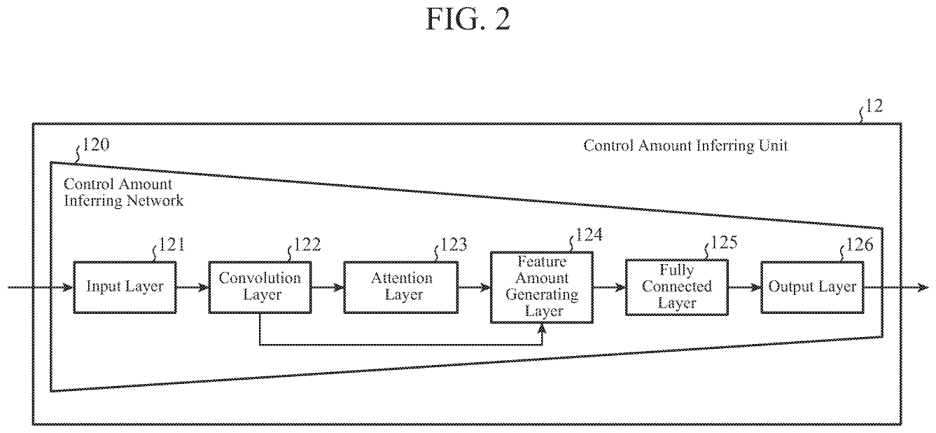

Here, FIG. 2 is a diagram for describing a configuration of the control amount inferring unit 12 in the control device 1 according to the first embodiment in detail.

As illustrated in FIG. 2, the control amount inferring unit 12 holds a control amount inferring network 120.

The control amount inferring network 120 is constituted by a neural network that receives, as an input, the captured image included in the surrounding situation information output from the surrounding situation acquiring unit 11 and outputs the control amount of the vehicle 100. That is, the control amount inferring network 120 is a machine learning model that receives, as an input, the captured image and outputs the control amount of the vehicle 100.

The control amount inferring network 120 includes an input layer 121, a convolution layer 122, an attention layer 123, a feature amount generating layer 124, a fully connected layer 125, and an output layer 126.

The control amount inferring network 120 receives the captured image in the input layer 121, and performs convolution processing on the captured image in the convolution layer 122. The attention layer 123 has attention-paid region information indicating an attention-paid region in the input captured image, and the control amount inferring network 120 extracts a latent feature amount generated by the feature amount generating layer 124 on the basis of a parameter of the attention layer 123 and a convolution result of the convolution layer 122. The control amount inferring network 120 infers the control amount of the vehicle 100 with respect to the latent feature amount generated by the feature amount generating layer 124 in the fully connected layer 125. Then, the control amount inferring network 120 outputs the inferred control amount of the vehicle 100 by the output layer 126.

The control amount inferring network 120 has been trained in advance so as to output a control amount of the vehicle 100 as appropriate as possible, and in the training process of the control amount inferring network 120, the attention layer 123 has also been trained simultaneously so as to correctly pay attention to a meaningful region.

That is, when the control amount of the vehicle 100 output from the control amount inferring network 120 is an appropriate control amount, the attention-paid region to which the attention layer 123 pays attention can be said to be a region useful for extracting an appropriate control amount. Note that, conversely, when the control amount of the vehicle 100 output from the control amount inferring network 120 is not an appropriate control amount, the attention-paid region to which the attention layer 123 pays attention can be said not to be a region useful for extracting an appropriate control amount. For example, when an unknown captured image is input to the control amount inferring network 120, the attention layer 123 does not have attention-paid region information indicating an attention-paid region useful for extracting an appropriate control amount of the vehicle 100, and the control amount inferring network 120 cannot output an appropriate control amount of the vehicle 100.

The control amount inferring unit 12 infers the control amount of the vehicle 100 based on the captured image around the vehicle 100 acquired by the surrounding situation acquiring unit 11, more specifically, the captured image acquiring unit 111 using the control amount inferring network 120 as described above, and acquires, from the control amount inferring network 120, attention-paid region information re gar an attention-paid region in the captured image when the control amount is inferred, in other words, attention-paid region information included in the attention layer 123.

The control amount inferring unit 12 outputs information regarding the inferred control amount of the vehicle 100 to the control determining unit 15. In addition, the control amount inferring unit 12 outputs the acquired attention-paid region information to the reliability determining unit 14.

The target detecting unit 13 detects a position of a target present around the vehicle 100 on the basis of the surrounding situation information acquired by surrounding situation acquiring unit 11, in other words, the captured image acquired by the captured image acquiring unit 111 from the camera 2 and the distance information acquired by the distance information acquiring unit 112 from the radar 3. In the first embodiment, the target detecting unit 13 detects the position of the target as the position of the target in the captured image included in the surrounding situation information.

In the first embodiment, the position of the target in the captured image is represented by pixels on the captured image. The target detecting unit 13 performs detection using a range in which the target appears in the captured image as the position of the target and using the pixels included in the range as information indicating the position of the target.

For example, the target detecting unit 13 only needs to specify a range in which the target appears in the captured image using the distance information. As described above, the distance information includes information regarding the position and angle of the target detected by the radar 3 as viewed from the vehicle 100, and the distance between the vehicle 100 and the target. In addition, an installation position and an angle of view of the camera 2 mounted on the vehicle 100 are known in advance. Therefore, the target detecting unit 13 can specify a range in which the target indicated by the distance information appears in the captured image on the basis of the distance information and the captured image.

In addition, for example, the target detecting unit 13 may detect a target that appears in the captured image using a known image recognition processing technique for the captured image. Note that, in this case, the target detecting unit 13 does not need the distance information. Therefore, the surrounding situation acquiring unit 11 does not necessarily include the distance information acquiring unit 112.

In the first embodiment, the target detected by the target detecting unit 13 may be the entire target or a part of the target. As a specific example, for example, the target detecting unit 13 may detect the whole of another vehicle as the target, or may detect only a tail lamp of another vehicle as the target. When the target detecting unit 13 detects the whole of another vehicle as the target, the position of the target is represented by the pixels included in a range in which the whole of another vehicle appears in the captured image. When the target detecting unit 13 detects only a tail lamp of another vehicle as the target, the position of the target is represented by the pixels included in a range in which the tail lamp appears in the captured image.

The target detecting unit 13 outputs information regarding the detected position of the target (hereinafter, referred to as “target position information”) to the reliability determining unit 14. In the first embodiment, the target position information is information indicating the pixels in a range in which the target appears in the captured image.

The reliability determining unit 14 determines the reliability of the control amount of the vehicle 100 inferred by the control amount inferring unit 12 on the basis of the attention-paid region information output from the control amount inferring unit 12 and the target position information output from the target detecting unit 13.

Specifically, the reliability determining unit 14 compares the attention-paid region with the target position on the basis of the target position information output from the target detecting unit 13, calculates a coincidence degree between the attention-paid region and the target position, and determines the reliability of the control amount of the vehicle 100 inferred by the control amount inferring unit 12 depending on the calculated coincidence degree.

For example, when an automatic driving control device or the like automatically drives the vehicle 100, it is conceivable that attention should be paid to a predetermined target such as another traffic participant, a road sign, a road display, or a traffic signal as described above, and attention does not need to be paid to an object or the like other than the predetermined target, such as cloud or a roadside house. That is, when an automatic driving control device or the like automatically drives the vehicle 100, the control amount of the vehicle 100 should be a control amount estimated by paying attention not to an object or the like other than the target but to the target.

Meanwhile, as described above, when the control amount of the vehicle 100 output from the control amount inferring network 120 is an appropriate control amount, the attention-paid region to which the attention layer 123 pays attention can be said to be a region useful for extracting an appropriate control amount.

Therefore, in the control device 1, the reliability determining unit 14 determines the reliability of the control amount of the vehicle 100 output from the control amount inferring network 120 depending on whether or not the attention-paid region coincides with the target position, in other words, whether or not the control amount inferring network 120 can pay attention to the target when inferring the control amount of the vehicle 100.

The reliability determining unit 14 determines high reliability when the coincidence degree is high, and determines low reliability when the coincidence degree is low.

For example, the reliability determining unit 14 calculates the coincidence degree between the attention-paid region and the target position on the basis of an overlap degree between the attention-paid region and the target position. In addition, for example, the reliability determining unit 14 may calculate the coincidence degree between the attention-paid region and the target position on the basis of a result of determining whether or not each pixel is included in both the attention-paid region and the target region in a pixel unit of the captured image. In addition, for example, the reliability determining unit 14 may acquire the coincidence degree between the attention-paid region and the target position using a neural network that receives, as an input, the attention-paid region information and the target position information and outputs the coincidence degree. Note that the neural network in this case is assumed to be constructed in advance.

The reliability determined by the reliability determining unit 14 may be represented by, for example, a discrete value of “high” or “low”, or may be represented by a continuously changing numerical value.

As a specific example, for example, the reliability determining unit 14 determines that the reliability is “high” when the calculated coincidence degree is equal to or more than a preset threshold (hereinafter, referred to as “coincidence degree determining threshold”). Meanwhile, the reliability determining unit 14 determines that the reliability is “low” when the calculated coincidence degree is less than the coincidence degree determining threshold.

In addition, for example, the reliability determining unit 14 may classify the calculated coincidence degrees into groups and determine the reliability on the basis of the classified groups. For example, when the coincidence degree is represented by 0 to 100 and the reliability is represented by numerical values of 0 to 1, the reliability determining unit 14 may determine the reliability, in such a manner that the reliability is “0.2” when the coincidence degree is 0 to 20, the reliability is “0.4” when the coincidence degree is 21 to 40, the reliability is “0.6” when the coincidence degree is 41 to 60, the reliability is “0.8” when the coincidence degree is 61 to 80, and the reliability is “1” when the coincidence degree is 81 to 100.

The reliability determining unit 14 outputs the determined reliability to the control determining unit 15.

The control determining unit 15 determines whether or not to adopt the control amount of the vehicle 100 inferred by the control amount inferring unit 12 as the control amount of the vehicle 100 on the basis of the reliability output from the reliability determining unit 14.

For example, the control determining unit 15 determines whether or not to adopt the control amount of the vehicle 100 inferred by the control amount inferring unit 12 by comparing the reliability output from the reliability determining unit 14 with a preset threshold (hereinafter, referred to as “reliability determining threshold”). For example, when the reliability determined by the reliability determining unit 14 exceeds the reliability determining threshold, the control determining unit 15 determines to adopt the control amount of the vehicle 100 inferred by the control amount inferring unit 12. Meanwhile, when the reliability determined by the reliability determining unit 11 is equal to or less than the reliability determining threshold, the control determining unit 15 determines not to adopt the control amount of the vehicle 100 inferred by the control amount inferring unit 12.

When the control determining unit 15 determines to adopt the control amount of the vehicle 100 inferred by the control amount inferring unit 12 as the control amount of the vehicle 100, the control determining unit 15 outputs information regarding the control amount of the vehicle 100 inferred by the control amount inferring unit 12 to the actuator 16.

Meanwhile, when the control determining unit 15 determines not to adopt the control amount of the vehicle 100 inferred by the control amount inferring unit 12 as the control amount of the vehicle 100, the control determining unit 15 switches the vehicle 100 from the automatic driving to manual driving, for example.

The actuator 16 controls the vehicle 100 on the basis of the information regarding the control amount of the vehicle 100 output from the control determining unit 15. Specifically, the actuator 16 performs steering wheel control, throttle control, and brake control on the basis of the information regarding the control amount of the vehicle 100 output from the control determining unit 15.

Note that, in the first embodiment, the control determining unit 15 determines whether to perform control based on the control amount of the vehicle 100 inferred by the control amount inferring unit 12 on the vehicle 100 via the actuator 16 or to switch the vehicle 100 to manual driving without performing the control based on the control amount by comparing the reliability output from the reliability determining unit 14 with the reliability determining threshold, but this is merely an example. It is possible to appropriately set what determination or control the control determining unit 15 performs on the basis of the reliability output from the reliability determining unit 14.

The control determining unit 15 can also adjust the control amount of the vehicle 100 to be output to the actuator 16 on the basis of the reliability output from the reliability determining unit 14.

For example, the control determining unit 15 can calculate a control amount (hereinafter, referred to as “mixed control amount”) obtained by mixing the control amount of the vehicle 100 inferred by the control amount inferring unit 12 and a control amount in a control amount inferring means different from the control amount inferring unit 12 on the basis of the reliability output from the reliability determining unit 14, and output the mixed control amount to the actuator 16. Note that this example is based on the premise that the control device 1 includes a control amount inferring means different from the control amount inferring unit 12 as a means for inferring the control amount of the vehicle 100. The control amount inferring means different from the control amount inferring unit 12 can be any appropriate means, and is, for example, an in-vehicle device different from the control device 1. Iii addition, for example, the control amount inferring means different from the control amount inferring unit 12 may be manual driving.

The control determining unit 15 calculates the mixed control amount on the basis of the reliability output from the reliability determining unit 14 using, for example, a weighted average method.

A method in which the control determining unit 15 calculates the mixed control amount will be described with a specific example. Note that, in the following description of the specific example, the control amount inferring means different from the control amount inferring unit 12 is referred to as “alternative control”.

### First Specific Example

For example, it is presumed that “accelerator: 60%, brake: 0%, steering: 0°” is obtained as the control amount of the vehicle 100 inferred by the control amount inferring unit 12.

Meanwhile, in the alternative control, it is presumed that “accelerator: 70%, brake: 0%, steering: 20°” is obtained as the control amount of the vehicle 100.

In addition, it is presumed that the reliability output from the reliability determining unit 14 is “0.9”.

In this case, the control determining unit 15 calculates a mixed control amount of the accelerator as “61%” by the following calculation.

60×0.9+70×(1−0.9)=61

In addition, the control determining unit 15 calculates a mixed control amount of the brake as “0%” by the following calculation formula.

0×0.9+0×(1−0.9)=0

In addition, the control determining unit 15 calculates a mixed control amount of the steering as “2°” by the following calculation formula.

0×0.9+20×(1−0.9)=2

Then, the control determining unit 15 outputs the mixed control amounts “accelerator: 61%, brake: 0%, steering: 2°” to the actuator 16 as the control amount of the vehicle 100.

### Second Specific Example

For example, similarly to <First Specific Example>, it is presumed that “accelerator: 60%, brake: 0%, steering: 0°” is obtained as the control amount of the vehicle 100 inferred by the control amount inferring unit 12.

In addition, also in the alternative control, similarly to <First Specific Example>, it is presumed that “accelerator: 70%, brake: 0%, steering: 20°” is obtained as the control amount of the vehicle 100.

However, it is presumed that the reliability output from the reliability determining unit 14 is “0.1”.

In this case, the control determining unit 15 calculates mixed control amounts “accelerator: 69%, brake: 0%, steering: 18°” as the control amount of the vehicle 100.

Note that calculation formulas used to calculate the mixed control amount of the accelerator, the mixed control amount of the brake, and the mixed control amount of the steering are similar to the calculation formulas used to calculate the mixed control amount of the accelerator, the mixed control amount of the brake, and the mixed control amount of the steering in <First Specific Example>, respectively, and therefore duplicate description is omitted.

Then, the control determining unit 15 outputs the mixed control amounts “accelerator: 69%, brake: 0%, steering: 18°” to the actuator 16.

As in <First Specific Example>, when the reliability output from the reliability determining unit 14 is high, that is, when it can be said that the reliability of the control amount of the vehicle 100 inferred by the control amount inferring unit 12 is high, the control determining unit 15 calculates a control amount close to the control amount of the vehicle 100 inferred by the control amount inferring unit 12 as the mixed control amount, and outputs the calculated control amount to the actuator 16.

Meanwhile, as in <Second Specific Example>, when the reliability output from the reliability determining unit 14 is low, that is, when it can be said that the reliability of the control amount of the vehicle 100 inferred by the control amount inferring unit 12 is low, the control determining unit 15 calculates a control amount close to the control amount by the alternative control as the mixed control amount, and outputs the calculated control amount to the actuator 16.

As described above, the control determining unit 15 can adjust how much the control amount of the vehicle 100 inferred by the control amount inferring unit 12 is actually adopted depending on the reliability output from the reliability determining unit 14.

For example, as in the above-described example, when the control determining unit 15 determines whether to perform control based on the control amount of the vehicle 100 inferred by the control amount inferring unit 12 on the vehicle 100 via the actuator 16 by comparing the reliability output from the reliability determining unit 14 with the reliability determining threshold, the control amount of the vehicle 100 is not adopted even when the reliability of the control amount of the vehicle 100 is high to some extent because the reliability is less than the reliability determining threshold. However, it can be said that the control amount whose reliability is high to some extent is also based on the target to some extent, and there is a possibility that the control amount is an appropriate control amount.

Therefore, as in <First Specific Example> and <Second Specific Example>, by making it possible to calculate a mixed control amount obtained by mixing the control amount of the vehicle 100 inferred by the control amount inferring unit 12 and a control amount in a control amount inferring means different from the control amount inferring unit 12 on the basis of the reliability output from the reliability determining unit 14, the control determining unit 15 can adopt the control amount of the vehicle 100 inferred by the control amount inferring unit 12 as the control amount of the vehicle 100 to be output to the actuator 16 by the rate corresponding to the reliability.

Note that, for example, the control determining unit 15 may combine a method for determining the control amount of the vehicle 100 to be output to the actuator 16 using the reliability determining threshold and a method for determining the mixed control amount as the control amount of the vehicle 100 to be output to the actuator 16. For example, the control determining unit 15 may determine to adopt the control amount of the vehicle 100 inferred by the control amount inferring unit 12 as the control amount to be output to the actuator 16 when the reliability determined by the reliability determining unit 14 exceeds the reliability determining threshold, and may determine to calculate the mixed control amount and to adopt the calculated mixed control amount as the control amount to be output to the actuator 16 when the reliability determined by the reliability determining unit 14 does not exceed the reliability determining threshold.

An operation of the control device 1 will be described,

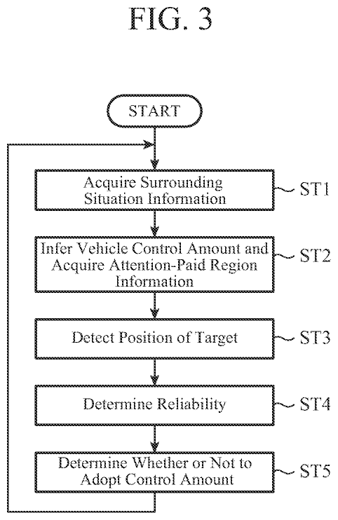

FIG. 3 is a flowchart for describing the operation of the control device 1 according to the first embodiment.

Note that the operation of the control device 1 illustrated in FIG. 3 is an operation of the control device 1 in a case of including the control determining unit 15. The control device 1 repeatedly performs the operation illustrated in the flowchart of FIG. 3, for example, during automatic driving of the vehicle 100.

The surrounding situation acquiring unit 11 acquires surrounding situation information from the camera 2 and the radar 3 (step ST1).

Specifically, the captured image acquiring unit 111 of the surrounding situation acquiring unit 11 acquires, from the camera 2, a captured image obtained by capturing surroundings of the vehicle 100. The distance information acquiring unit 112 of the surrounding situation acquiring unit 11 acquires, from the radar 3, distance information to an object present around the vehicle 100.

The surrounding situation acquiring unit 11 outputs the acquired surrounding situation information to the control amount inferring unit 12 and the target detecting unit 13.

The control amount inferring unit 12 infers the control amount of the vehicle 100 on the basis of the surrounding situation information acquired by the surrounding situation acquiring unit 11 in step ST1, and acquires attention-paid region information regarding an attention-paid region in the surrounding situation information used when the control amount is inferred (step ST2).

More specifically, the control amount inferring unit 12 infers the control amount of the vehicle 100 on the basis of the captured image included in the surrounding situation information acquired by the surrounding situation acquiring unit 11, and acquires attention-paid region information regarding an attention-paid region in the captured image when the control amount is inferred.

The control amount inferring unit 12 outputs information regarding the inferred control amount of the vehicle 100 to the control determining unit 15. In addition, the control amount inferring unit 12 outputs the acquired attention-paid region information to the reliability determining unit 14.

The target detecting unit 13 detects a position of the target on the basis of the surrounding situation information acquired by surrounding situation acquiring unit 11 in step ST1, in other words, the captured image acquired by the captured image acquiring unit 111 from the camera 2 and the distance information acquired by the distance information acquiring unit 112 from the radar 3 (step ST3).

The target detecting unit 13 outputs target position information regarding the detected position of the target to the reliability determining unit 14.

The reliability determining unit 14 determines reliability of the control amount of the vehicle 100 inferred by the control amount inferring unit 12 on the basis of the attention-paid region information output from the control amount inferring unit 12 in step ST2 and the target position information output from the target detecting unit 13 in step ST3 (step ST4).

The reliability determining unit 14 outputs the determined reliability to the control determining unit 15.

For example, the control determining unit 15 determines whether or not to adopt the control amount of the vehicle 100 inferred by the control amount inferring unit 12 in step ST2 as the control amount of the vehicle 100 on the basis of the reliability output from the reliability determining unit 14 in step ST4 (step ST5).

When the control determining unit 15 determines to adopt the control amount of the vehicle 100 inferred by the control amount inferring unit 12 as the control amount of the vehicle 100, the control determining unit 15 outputs information regarding the control amount of the vehicle 100 inferred by the control amount inferring unit 12 to the actuator 16.

The actuator 16 controls the vehicle 100 on the basis of the information regarding the control amount of the vehicle 100 output from the control determining unit 15.

Meanwhile, when the control determining unit 15 determines not to adopt the control amount of the vehicle 100 inferred by the control amount inferring unit 12 as the control amount of the vehicle 100, the control determining unit 15 switches the vehicle 100 from the automatic driving to manual driving, for example.

Note that the operation of the control device 1 is executed in order of steps ST2 and ST3 in FIG. 3, but this order is not essential. The control device 1 may execute step ST3 and step ST2 in this order, or may execute the operation of step ST2 and the operation of step ST3 in parallel.

In general, it is difficult to guarantee that a machine learning model constituted by a neural network such as the control amount inferring network 120 in machine learning performs an appropriate output for every possible input. This is because it is difficult to completely cover every possible situation as training data. That is, the machine learning model cannot guarantee an output for an unknown state that is not a learning target when the machine learning is performed.

Meanwhile, the control amount inferring network 120 learns an appropriate output of the control amount of the vehicle 100 for various inputs, that is, the captured image in the above first embodiment in a training process of the control amount inferring network 120, and the attention layer 123 simultaneously learns so as to pay attention to an appropriate region. Therefore, when learning for certain training data ends and the control amount inferring network 120 can output an appropriate control amount of the vehicle 100, it is conceivable that the attention layer 123 can also be trained so as to pay attention to an appropriate region in the control amount inferring network 120. Conversely, when attention cannot be paid to an appropriate region for a certain input, a control amount output from the control amount inferring network 120 for the input may be inappropriate. If the vehicle 100 is controlled using an inappropriate control amount, the vehicle 100 may cause an inappropriate behavior, which may cause a traffic accident, a failure of the vehicle, or the like. Therefore, when the control amount output from the control amount inferring network 120 is inappropriate, the control device 1 needs to avoid controlling the vehicle 100 using the control amount.

On the other hand, as described above, the control device 1 according to the first embodiment determines the reliability of the control amount of the vehicle 100 output from the control amount inferring network 120 depending on whether or not the control amount inferring network 120 pays attention to the target when inferring the control amount of the vehicle 100. At this time, when the control device 1 determines that the control amount inferring network 120 cannot pay attention to the target when inferring the control amount of the vehicle 100, the control device 1 determines the reliability in such a manner that the reliability is low. Then, the control device 1 outputs the determined reliability to the control determining unit 15 together with the control amount of the vehicle 100 inferred using the control amount inferring network 120.

As described above, the control device 1 can determine whether or not the control amount inferred as the control amount for controlling the control target apparatus is reliable on the basis of the attention-paid region information acquired when the control amount of the vehicle 100 is inferred by inputting a captured image to the control amount inferring network 120 and the target position information based on the captured image.

By the control device 1 outputting the determined reliability of the control amount together with the inferred control amount, the control determining unit 15 can prevent, for example, a control amount with low reliability, in other words, a control amount inferred for an input for which learning of the control amount inferring network 120 may be incomplete from being used for control of the vehicle 100.

That is, the control device 1 can more appropriately output the control amount of the vehicle 100 as compared with a case of outputting the control amount without determining the reliability.

In the above first embodiment, in the control device 1, the control amount inferring unit 12 infers the control amount of the vehicle 100 on the basis of the captured image included in the surrounding situation information, and acquires attention-paid region information regarding an attention-paid region in the captured image when the control amount is inferred. In addition, the target detecting unit 13 detects the position of the target as the position of the target in the captured image included in the surrounding situation information.

It is not limited thereto, and the control amount inferring unit 12 may infer the control amount of the vehicle 100 on the basis of information (hereinafter, referred to as “point cloud data”) indicating a distance and an angle with respect to a target present around the vehicle 100, and may acquire attention-paid region information regarding an attention-paid region in the point cloud data when the control amount is inferred. In this case, the target detecting unit 13 detects a position of the target as a position in a real space based on the point cloud data.

In this case, the control device 1 is connected to a LiDAR (not illustrated) instead of the camera 2 and the radar 3. Note that the LiDAR is mounted on the vehicle 100. The LiDAR outputs the point cloud data to the control device 1. The surrounding situation acquiring unit 11 of the control device 1 acquires the point cloud data output from the LiDAR as surrounding situation information.

Note that, in this case, the surrounding situation acquiring unit 11 can have a configuration not including the captured image acquiring unit 111 or the distance information acquiring unit 112.

As described above, in the control device 1, the surrounding situation information includes the point cloud data indicating a distance and an angle of a target present around the vehicle 100 with respect to the vehicle 100, and even when the control amount inferring unit 12 infers the control amount of the vehicle 100 on the basis of the point cloud data and acquires attention-paid region information regarding an attention-paid region in the point cloud data used when the control amount is inferred, the control device 1 can determine whether or not the control amount inferred as the control amount for controlling the control target apparatus is reliable.

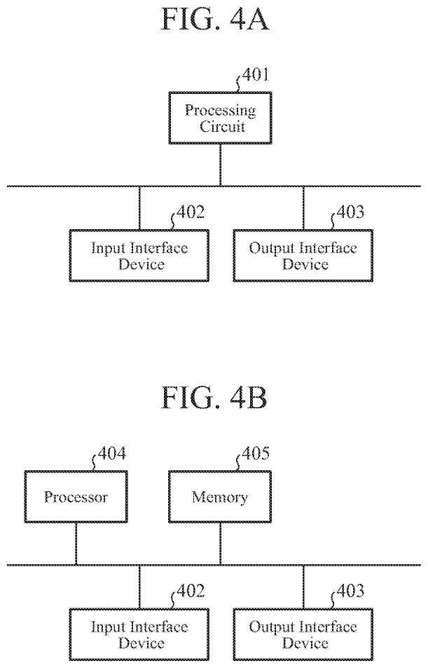

FIGS. 4A and 4B are each a diagram illustrating an example of a hardware configuration of the control device 1 according to the first embodiment.

An example of the hardware configuration of the control device 1 will be described on the premise that the control device 1 includes the control determining unit 15.

In the first embodiment, the functions of the surrounding situation acquiring unit 11, the control amount inferring unit 12, the target detecting unit 13, the reliability determining unit 14, and the control determining unit 15 are implemented by a processing circuit 401. That is, the control device 1 includes the processing circuit 401 for performing control of inferring a control amount for controlling the vehicle 100 and determining reliability of the inferred control amount.

The processing circuit 401 may be dedicated hardware as illustrated in FIG. 4A, or a processor 404 that executes a program stored in a memory as illustrated in FIG. 4B.

When the processing circuit 401 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 401.

When the processing circuit is the processor 404, the functions of the surrounding situation acquiring unit 11, the control amount inferring unit 12, the target detecting unit 13, the reliability determining unit 14, and the control determining unit 15 are implemented by software, firmware, or a combination of software and firmware. Software or firmware is described as a program and stored in a memory 405. By reading and executing the program stored in the memory 405, the processor 404 executes the functions of the surrounding situation acquiring unit 11, the control amount inferring unit 12, the target detecting unit 13, the reliability determining unit 14, and the control determining unit 15. That is, the control device 1 includes the memory 405 for storing a program that causes steps ST1 to ST5 illustrated in FIG. 3 described above to be executed as a result when the program is executed by the processor 404. It can also be said that the program stored in the memory 405 causes a computer to execute the procedures or methods of processing performed by the surrounding situation acquiring unit 11, the control amount inferring unit 12, the target detecting unit 13, the reliability determining unit 14, and the control determining unit 15. Here, for example, a nonvolatile or volatile semiconductor memory such as a RAM, a read only memory (ROM), a flash memory, an erasable programmable read only memory (EPROM), or an electrically erasable programmable read-only memory (EEPROM), a magnetic disk, a flexible disk, an optical disc, a compact disc, a mini disc, or a digital versatile disc (DVD) corresponds to the memory 405.

Note that some of the functions of the surrounding situation acquiring unit 11, the control amount inferring unit 12, the target detecting unit 13, the reliability determining unit 14, and the control determining unit 15 may be implemented by dedicated hardware, and some of the functions may be implemented by software or firmware. For example, the function of the surrounding situation acquiring unit 11 can be implemented by the processing circuit 401 as dedicated hardware, and the functions of the control amount inferring unit 12, the target detecting unit 13, the reliability determining unit 14, and the control determining unit 15 can be implemented by the processor 404 reading and executing a program stored in the memory 405.

In addition, the control device 1 includes an input interface device 402 and an output interface device 403 for performing wired communication or wireless communication with a device such as the camera 2, the radar 3, the actuator 16, or a LiDAR.

In the above first embodiment, the control device 1 is an in-vehicle device mounted on the vehicle 100, and the surrounding situation acquiring unit 11, the control amount inferring unit 12, the target detecting unit 13, and the reliability determining unit 14 are included in the control device 1, control determining unit 15 is also included in the vehicle 100.

It is not limited thereto, and some of the surrounding situation acquiring unit 11, the control amount inferring unit 12, the target detecting unit 13, the reliability determining unit 14, and the control determining unit 15 may be included in an in-vehicle device of the vehicle 100, and the others may be included in a server connected to the in-vehicle device via a network. In this manner, the in-vehicle device and the server may constitute a control system.

In addition, in the above first embodiment, the control target apparatus is considered to be the vehicle 100 capable of automatic driving, but this is merely an example.

The control device 1 can control various apparatuses. Specifically, for example, an industrial robot, an automatic guided vehicle, or an aircraft can also be used as the control target apparatus of the control device 1.

As described above, according to the first embodiment, the control device 1 includes: the surrounding situation acquiring unit 11 that acquires surrounding situation information regarding a situation around a control target apparatus; the control amount inferring unit 12 that infers a control amount of the control target apparatus on the basis of the surrounding situation information acquired by the surrounding situation acquiring unit 11 and acquires attention-paid region information regarding an attention-paid region in the surrounding situation information used when the control amount is inferred; the target detecting unit 13 that detects a position of a target present around the control target apparatus on the basis of the surrounding situation information acquired by the surrounding situation acquiring unit 11; and the reliability determining unit 11 that determines reliability of the control amount inferred by the control amount inferring unit 12 on the basis of the attention-paid region information acquired by the control amount inferring unit 12 and target position information regarding the position of the target detected by the target detecting unit 13. Therefore, the control device 1 can determine whether or not the control amount inferred as the control amount for controlling the control target apparatus is reliable. Then, the control device 1 can more appropriately output the control amount of the vehicle 100 as compared with a case of outputting the control amount without determining the reliability.

### Second Embodiment

in the first embodiment, the control device does not consider control content of the control target apparatus in inferring the control amount of the control target apparatus and acquiring the attention-paid region information.

In a second embodiment, an embodiment will be described in which a control device infers a control amount of a control target apparatus and acquires attention-paid region information in consideration of control content of the control target apparatus.

Also in the second embodiment, as in the first embodiment, the control target apparatus is considered to be a vehicle capable of automatic driving. The control device performs automatic driving control in a vehicle capable of automatic driving.

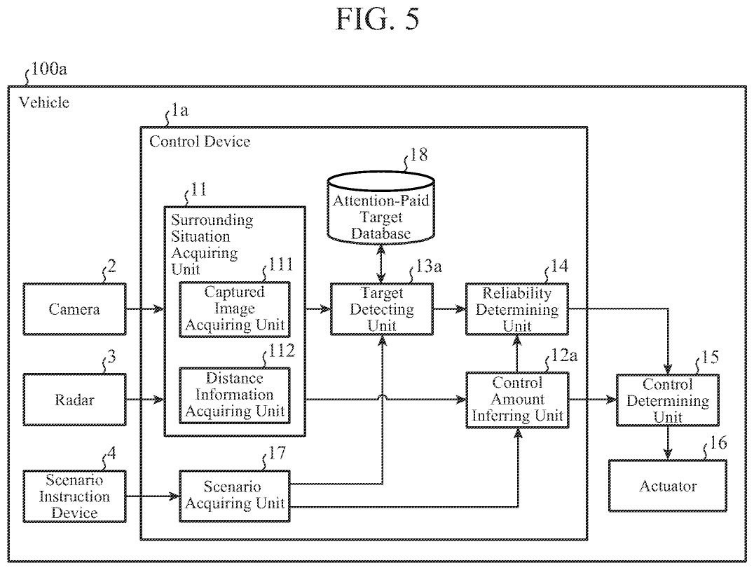

FIG. 5 is a diagram illustrating a configuration example of a control device 1a according to the second embodiment.

The control device 1a is mounted on a vehicle 100a.

In the second embodiment, a scenario indicating device 4 is mounted on the vehicle 100a, and the control device 1a is connected to the scenario indicating device 4.

The scenario indicating device 4 is, for example, a touch panel display. The scenario indicating device 4 receives a control scenario for automatic driving control of the vehicle 100a, and outputs information (hereinafter, referred to as “control scenario information”) regarding the received control scenario to the control device 1a. In the second embodiment, the control scenario indicates control content of a control target apparatus. More specifically, the control scenario indicates an operation to be implemented by the control target apparatus. That is, here, the control scenario indicates an operation to be implemented by the vehicle 100a. As a specific example, the control scenario is, for example, “following a preceding vehicle”, “turning right at an intersection”, or “stopping on a road shoulder”.

For example, an occupant of the vehicle 100a operates by touching the scenario indicating device 4 or the like, inputs the control scenario from the scenario indicating device 4, and designates the control scenario. The scenario indicating device 4 receives the control scenario input by the occupant. Then, the scenario indicating device 4 outputs the control scenario information to the control device 1a. The control scenario information includes information capable of specifying the designated control scenario.

In the configuration of the control device 1a according to the second embodiment, similar components to those of the control device 1 described using FIG. 1 in the first embodiment are denoted by the same reference numerals, and redundant description is omitted.

The control device 1a is different from the control device 1 according to the first embodiment in that the control device 1a includes a scenario acquiring unit 17. In addition, the control device 1a is different from the control device 1 according to the first embodiment in a detailed configuration of a control amount inferring unit 12a. In addition, the control device 1a is different from the control device 1 according to the first embodiment in a specific operation of a target detecting unit 13a. In addition, the control device 1a is different from the control device 1 according to the first embodiment in that the control device 1a includes an attention-paid target database 18.

Note that, in FIG. 5, the attention-paid target database 18 is included in the control device 1a, but this is merely an example. The attention-paid target database 18 may be disposed at a place that is located outside the control device 1a and can be referred to by the control device 1a.

The scenario acquiring unit 17 acquires the control scenario information output from the scenario indicating device 4.

The scenario acquiring unit 17 outputs the acquired control scenario information to the control amount inferring unit 12a and the target detecting unit 13a,

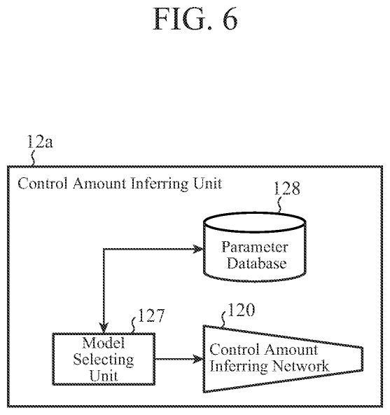

FIG. 6 is a diagram for describing a configuration of the control amount inferring unit 12a in the control device 1a according to the second embodiment in detail.

In the configuration of the control amount inferring unit 12a according to the second embodiment, similar components to those of the control amount inferring unit 12 described using FIG. 2 in the first embodiment are denoted by the same reference numerals, and redundant description is omitted.

The control amount inferring unit 12a is different from the control amount inferring unit 12 of the first embodiment in that the control amount inferring unit 12a includes a model selecting unit 127 and a parameter database 128.

The model selecting unit 127 sets a parameter such as a weight of a layer of a neural network, in other words, a control amount inferring network 120 on the basis of the control scenario information acquired by the scenario acquiring unit 17.

The parameter database 128 stores information (hereinafter, referred to as “parameter information”) in which a control scenario and a parameter corresponding to the control scenario are associated with each other.

The model selecting unit 127 determines the parameter corresponding to the control scenario by performing matching of the control scenario specified from the control scenario information and the control scenario of the parameter information.

Note that, here, the control amount inferring unit 12a includes the parameter database 128, but this is merely an example. The parameter database 128 only needs to be disposed at a place that can be referred to by the control amount inferring unit 12a.

On the basis of surrounding situation information acquired by a surrounding situation acquiring unit 11, the control amount inferring unit 12a infers a control amount of the vehicle 100a and acquires attention-paid region information using the control amount inferring network 120 in which a parameter is set on the basis of the control scenario information acquired by the scenario acquiring unit 17.

That is, the control amount inferring unit 12a infers the control amount of the vehicle 100a based on the surrounding situation information acquired by the surrounding situation acquiring unit 11, more specifically, based on a captured image around the vehicle 100a acquired by a captured image acquiring unit 111 using the control amount inferring network 120 in which a parameter is set on the basis of the control scenario by the model selecting unit 127, and acquires, from the control amount inferring network 120, attention-paid region information regarding an attention-paid region in the captured image when the control amount is inferred, in other words, attention-paid region information included in the attention layer 123.

As a result, the control amount inferring unit 12a can infer a control amount of the vehicle 100a corresponding to the control scenario and can acquire attention-paid region information corresponding to the control scenario. That is, the control amount interring unit 12a can infer a control amount of the vehicle 100a specializing in a given control scenario and can acquire attention-paid region information specializing in the given control scenario.

The control amount inferring unit 12a outputs information regarding the inferred control amount of the vehicle 100a corresponding to the control scenario to a control determining unit 15. In addition, the control amount inferring unit 12a outputs the acquired attention-paid region information corresponding to the control scenario to a reliability determining unit 14.

The target detecting unit 13a detects a position of a target present around the vehicle 100a on the basis of the surrounding situation information acquired by the surrounding situation acquiring unit 11 and the control scenario information acquired by the scenario acquiring unit 17. In the second embodiment, the target detecting unit 13a detects the position of the target as the position of the target in the captured image included in the surrounding situation information.

In the second embodiment, the position of the target in the captured image is represented by the pixels on the captured image. The target detecting unit 13a performs detection using a range in which the target appears in the captured image as the position of the target and using the pixels included in the range as information indicating the position of the target.

Since a method in which the target detecting unit 13a detects the position of the target in the captured image only needs to be similar to the method in which the target detecting unit 13 detects the position of the target in the captured image, described in the first embodiment, redundant description is omitted.

Note that, in the first embodiment, the target detecting unit 13 detects all preset targets as targets whose positions are to be detected, whereas in the second embodiment, the target detecting unit 13a narrows down targets to be detected on the basis of the control scenario information acquired by the scenario acquiring unit 17. Specifically, the target detecting unit 13a narrows down targets (hereinafter, referred to as “targets to be detected”) whose positions are to be detected among preset targets by referring to the attention-paid target database 18. The target detecting unit 13a detects a position of a target to be detected.

The attention-paid target database 18 holds information (hereinafter, referred to as “each scenario target information”) in which a target to which attention should be paid and a region to which attention should be paid are associated with each other for each control scenario.

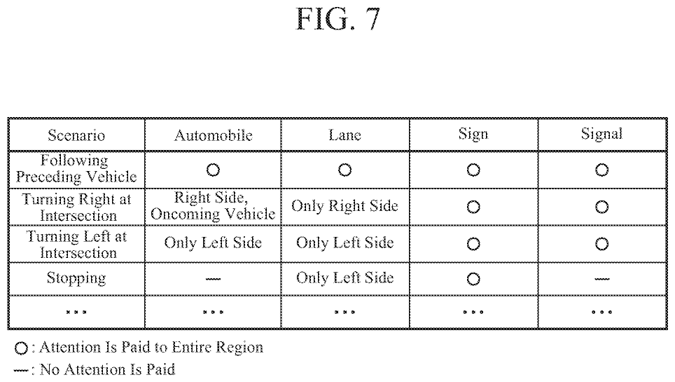

Here, FIG. 7 is a diagram illustrating a concept of an example of content of the each scenario target information held in the attention-paid target database 18 in the second embodiment. Note that, here, an automobile, a lane, a sign, and a signal are set in advance as targets.

According to the each scenario target information illustrated in FIG. 7, for example, when the control scenario is “following a preceding vehicle”, all the targets (an automobile, a lane, a sign, and a signal) are targets to be detected, and attention should be paid to all the targets in the entire region. In addition, according to the each scenario target information illustrated in FIG. 7, for example, when the control scenario is “turn right at an intersection”, all the targets are targets to be detected, but among the targets to be detected, attention should be paid to a vehicle traveling on the right side of the vehicle 100a and an oncoming vehicle for the automobile, and attention should be paid to a lane on the right side of the vehicle 100a for the lane. In addition, according to the each scenario target information illustrated in FIG. 7, for example, when the control scenario is “stopping”, the vehicle and the signal are not used as the targets to be detected.

The target detecting unit 13a narrows down the targets to be detected by referring to the attention-paid target database 18, and then detects a position of a target to be detected obtained by narrowing down.

The target detecting unit 13a outputs target position information regarding the detected position of the target, more specifically, target position information regarding the detected position of the target to be detected to the reliability determining unit 14.

An operation of the control device 1a according to the second embodiment will be described.

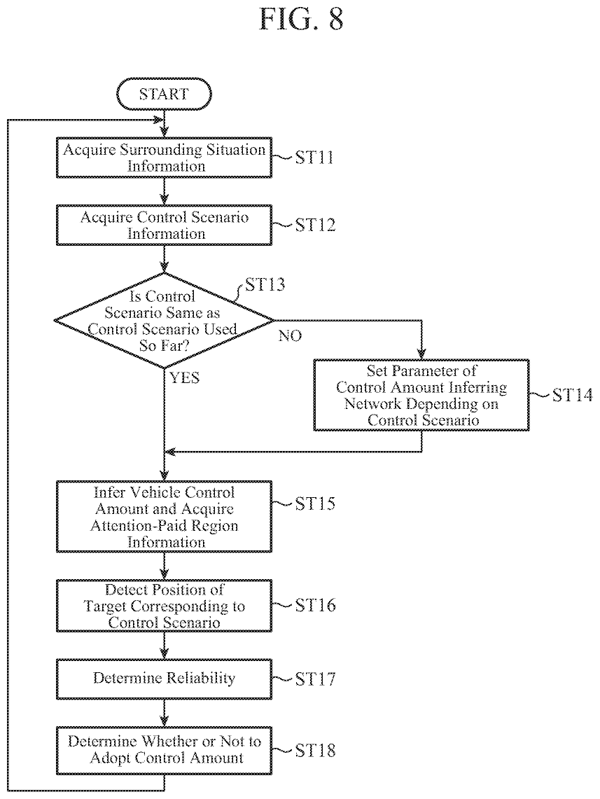

FIG. 8 is a flowchart for describing the operation of the control device 1a according to the second embodiment.

Note that the operation of the control device 1a illustrated in FIG. 8 is an operation of the control device 1a in a case of including the control determining unit 15. The control device 1a repeatedly performs the operation illustrated in the flowchart of FIG. 8, for example, during automatic driving of the vehicle 100a.

Since specific operations in steps ST11, ST17, and ST18 in FIG. 8 are similar to those in steps ST1, ST4, and ST5 in FIG. 3 described in the first embodiment, respectively, redundant description is omitted.

The scenario acquiring unit 17 acquires the control scenario information output from the scenario indicating device 4 (step ST12).

The scenario acquiring unit 17 outputs the acquired control scenario information to the control amount inferring unit 12a and the target detecting unit 13a.

The model selecting unit 127 determines whether or not the control scenario is the same as the control scenario used so far on the basis of the control scenario information acquired by the scenario acquiring unit 17 in step ST12 (step ST13).

If the model selecting unit 127 determines that the control scenario is the same as the control scenario used so far (“YES” in step ST13), the operation of the control device 1a proceeds to step ST15.

If the model selecting unit 127 determines that the control scenario is different from the control scenario used so far (“NO” in step ST13), the model selecting unit 127 sets a parameter such as a weight of a layer of a neural network, in other words, the control amount inferring network 120 on the basis of the control scenario information acquired by the scenario acquiring unit 17 in step ST12 (step ST14). The parameter of the control amount inferring network 120 is changed from the currently set parameter of the control amount inferring network 120 to a parameter corresponding to the control scenario.

Note that, when step ST13 is executed for the first time, since there is no control scenario used before that, the model selecting unit 127 determines that the control scenario is different from the control scenario used so far. Then, the operation of the control device 1a proceeds to step ST15.

On the basis of the surrounding situation information acquired by the surrounding situation acquiring unit 11 in step ST11, the control amount inferring unit 12a infers the control amount of the vehicle 100a and acquires the attention-paid region information using the control amount inferring network 120 in which a parameter is set on the basis of the control scenario information acquired by the scenario acquiring unit 17 in step ST12 (step ST15).

The control amount inferring unit 12a outputs information regarding the inferred control amount of the vehicle 100a corresponding to the control scenario to the control determining unit 15. In addition, the control amount inferring unit 12a outputs the acquired attention-paid region information corresponding to the control scenario to the reliability determining unit 14.

The target detecting unit 13a detects a position of a target present around the vehicle 100a on the basis of the surrounding situation information acquired by the surrounding situation acquiring unit 11 in step ST11 and the control scenario information acquired by the scenario acquiring unit 17 in step ST12 (step ST16).

Specifically, the target detecting unit 13a narrows down the targets to be detected by referring to the attention-paid target database 18, and then detects a position of a target to be detected obtained by narrowing down.

The target detecting unit 13a outputs target position information regarding the detected position of the target, more specifically, target position information regarding the detected position of the target to be detected to the reliability determining unit 14.

The operation of the control device 1a is executed in order of steps ST13 to ST16 in FIG. 8, but this order is not essential. In the control device 1a, the order of the operation in steps ST13 to ST15 and the operation in step ST16 may be reversed, or the operation in steps ST13 to ST15 and the operation in step ST16 may be executed in parallel.

As described above, in the second embodiment, the control device 1a infers the control amount of the vehicle 100a using the control amount inferring network 120 different depending on the control scenario. The control device 1a can infer the control amount of the vehicle 100a using the control amount inferring network 120 specializing in the control scenario as compare with the control device 1 according to the first embodiment.

Since the control amount inferring network 120 is trained by specializing in the control scenario, training of the control amount inferring network 120 is easy.

When the control scenario is set, each control amount inferring network 120 does not need to pay attention to all the targets under any situation, and only needs to be able to pay attention to a target corresponding to the control scenario. Therefore, the control device 1a narrows down targets to be detected depending on the control scenario, and then detects a position of a target to be detected obtained by narrowing down. As a result, even when the control amount inferring network 120 is constituted for each control scenario, the control device 1a compares the attention-paid region with the target position, and can determine the reliability of the control amount of the vehicle 100a output from the control amount inferring network 120 depending on whether the control amount inferring network 120 pays attention to the target at the time of inferring the control amount of the vehicle 100a.

Then, by the control device 1a outputting the determined reliability of the control amount together with the inferred control amount, the control determining unit 15 can prevent, for example, a control amount with low reliability, in other words, a control amount inferred for an input for which training of the control amount inferring network 120 may be incomplete from being used for control of the vehicle 100a.

That is, the control device 1a can more appropriately output the control amount of the vehicle 100a as compared with a case of outputting the control amount without determining the reliability.

In the above second embodiment, in the control device 1a, the control amount inferring unit 12a infers the control amount of the vehicle 100a on the basis of the captured image included in the surrounding situation information, and acquires attention-paid region information regarding an attention-paid region in the captured image when the control amount is inferred. In addition, the target detecting unit 13a detects the position of the target as the position of the target in the captured image included in the surrounding situation information.

It is not limited thereto, and the control amount inferring unit 12a may infer the control amount of the vehicle 100a on the basis of point cloud data indicating a distance and an angle with respect to a target present around the vehicle 100a, and may acquire attention-paid region information regarding an attention-paid region in the point cloud data when the control amount is inferred. In this case, the target detecting unit 13a detects a position of the target as a position in a real space based on the point cloud data.

In this case, the control device 1a is connected to a LiDAR (not illustrated) instead of a camera 2 and a radar 3. Note that the LiDAR is mounted on the vehicle 100a. The LiDAR outputs the point cloud data to the control device 1a. The surrounding situation acquiring unit 11 of the control device 1a acquires the point cloud data output from the LiDAR as surrounding situation information.

Note that, in this case, the surrounding situation acquiring unit 11 can have a configuration not including the captured image acquiring unit 111 or a distance information acquiring unit 112.

As described above, in the control device 1a, the surrounding situation information includes the point cloud data indicating a distance and an angle of a target present around the vehicle 100a with respect to the vehicle 100a, and even if the control amount inferring unit 12a infers the control amount of the vehicle 100a on the basis of the point cloud data and acquires attention-paid region information regarding the attention-paid region in the point cloud data used when the control amount is inferred, the control device 1a can determine whether or not the control amount inferred as the control amount for controlling the control target apparatus is reliable.

Since a hardware configuration of the control device 1a according to the second embodiment is similar to the hardware configuration of the control device 1 described with reference to FIGS. 4A and 4B in the first embodiment, description thereof is omitted. Note that an example of the hardware configuration of the control device 1a will be described on the premise that the control device 1a includes the control determining unit 15.

In the second embodiment, the functions of the surrounding situation acquiring unit 11, the control amount inferring unit 12a, the target detecting unit 13a, the reliability determining unit 14, the control determining unit 15, and the scenario acquiring unit 17 are implemented by the processing circuit 401. That is, the control device 1a includes the processing circuit 401 for performing control of inferring a control amount for controlling the vehicle 100a depending on the control scenario and determining the reliability of the inferred control amount.

When the processing circuit is the processor 404, by reading and executing the program stored in the memory 405, the control device 1a executes the functions of the surrounding situation acquiring unit 11, the control amount inferring unit 12a, the target detecting unit 13a, the reliability determining unit 14, the control determining unit 15, and the scenario acquiring unit 17. That is, the control device 1a includes the memory 405 for storing a program that causes steps ST11 to ST18 illustrated in FIG. 8 described above to be executed as a result when the program is executed by the processing circuit. It can also be said that the program stored in the memory 405 causes a computer to execute the procedures or methods performed by the surrounding situation acquiring unit 11, the control amount inferring unit 12a, the target detecting unit 13a, the reliability determining unit 14, the control determining unit 15, and the scenario acquiring unit 17.

The attention-paid target database 18 is constituted by, for example, the memory 405.

In addition, the control device 1a includes the input interface device 402 and the output interface device 403 for performing wired communication or wireless communication with a device such as the camera 2, the radar 3, the scenario indicating device 4, an actuator 16, or a LiDAR.

In the above second embodiment, the control device 1a is an in-vehicle device mounted on the vehicle 100a, and the surrounding situation acquiring unit 11, the control amount inferring unit 12a, the target detecting unit 13a, the reliability determining unit 14, and the scenario acquiring unit 17 are included in the control device 1a. The control determining unit 15 is also included in the vehicle 100a.

It is not limited thereto, and some of the surrounding situation acquiring unit 11, the control amount inferring unit 12a, the target detecting unit 13a, the reliability determining unit 14, the control determining unit 15, and the scenario acquiring unit 17 may be included in an in-vehicle device of the vehicle 100a, and the others may be included in a server connected to the in-vehicle device via a network. In this manner, the in-vehicle device and the server may constitute a control system.

In addition, in the above second embodiment, for example, an industrial robot, an automatic guided vehicle, or an aircraft can also be used as the control target apparatus of the control device 1a.

As described above, according to the second embodiment, the control device 1a includes the scenario acquiring unit 17 that acquires control scenario information in which a control scenario indicating control content of a control target apparatus is designated, the control amount inferring unit 12a infers a control amount of the control target apparatus and acquires attention-paid region information on the basis of the surrounding situation information acquired by the surrounding situation acquiring unit 11 using a neural network (control amount inferring network 120) in which a parameter is set on the basis of the control scenario information acquired by the scenario acquiring unit 17, and the target detecting unit 13a detects a position of a target on the basis of the surrounding situation information acquired by the surrounding situation acquiring unit 11 and the control scenario information acquired by the scenario acquiring unit 17. Therefore, the control device 1a can determine whether or not the control amount inferred as the control amount for controlling the control target apparatus is reliable depending on the control content of the control target apparatus. Then, the control device 1a can more appropriately output the control amount of the vehicle 100 as compared with a case of outputting the control amount without determining the reliability.

Note that the present disclosure can freely combine the embodiments to each other, modify any constituent element in each of the embodiments, or omit any constituent element in each of the embodiments.

### INDUSTRIAL APPLICABILITY

The control device according to the present disclosure can determine whether or not the control amount inferred as the control amount for controlling the control target apparatus is reliable.

### REFERENCE SIGNS LIST

1, 1a: control device, 2: camera, 3: radar, 4: scenario indicating device, 11: surrounding situation acquiring unit, 111: captured image acquiring unit, 112: distance information acquiring unit, 12, 12a: control amount inferring unit, 120: control amount inferring network, 127: model selecting unit, 128: parameter database, 13, 13a: target detecting unit, 14: reliability determining unit. 15: control determining unit, 16: actuator, 17: scenario acquiring unit, 18: attention-paid target database, 401: processing circuit, 402: input interface device, 403: output interface device, 404: processor, 405: memory

1. A control device comprising processing circuitry
to acquire surrounding situation information regarding a situation around a control target apparatus,
to infer a control amount of the control target apparatus on a basis of the surrounding situation information and to acquire attention-paid region information regarding an attention-paid region in the surrounding situation information used when the control amount is inferred,
to detect a position of a target present around the control target apparatus on a basis of the surrounding situation information, and
to determine reliability of the control amount on a basis of the attention-paid region information and target position information regarding the position of the target.

2. The control device according to claim 1, wherein the processing circuitry infers the control amount and acquires the attention-paid region information using a neural network that has been trained.

3. The control device according to claim 1, wherein the processing circuitry further performs to determine whether or not to adopt the control amount which is inferred as a control amount of the control target apparatus on a basis of the reliability.

4. The control device according to claim 1, wherein the surrounding situation information includes a captured image obtained by capturing surroundings of the control target apparatus, and
the processing circuitry infers the control amount of the control target apparatus on a basis of the captured image, and acquires attention-paid region information regarding an attention-paid region in the captured image used when the control amount is inferred.

5. The control device according to claim 1, wherein the surrounding situation information includes point cloud data indicating a distance and an angle of the target present around the control target apparatus with respect to the control target apparatus and, and
the processing circuitry infers the control amount of the control target apparatus on a basis of the point cloud data, and acquires attention-paid region information regarding an attention-paid region in the point cloud data used when the control amount is inferred.

6. The control device according to claim 1, wherein the processing circuitry detects a position of a part of the target as the position of the target.

7. The control device according to claim 2, wherein the processing circuitry performs to acquire control scenario information in which a control scenario indicating control content of the control target apparatus is designated,
to infer the control amount of the control target apparatus and acquires the attention-paid region information on a basis of the surrounding situation information using the neural network in which a parameter is set on a basis of the control scenario information, and
to detect the position of the target on a basis of the surrounding situation information and the control scenario information.

8. A control method comprising:
acquiring surrounding situation information regarding a situation around a control target apparatus;
inferring a control amount of the control target apparatus on a basis of the surrounding situation information and acquiring attention-paid region information regarding an attention-paid region in the surrounding situation information used when the control amount is inferred;
detecting a position of a target present around the control target apparatus on a basis of the surrounding situation information; and
determining reliability of the control amount on a basis of the attention-paid region information and target position information regarding the position of the target.
